(19) United States
(12) Patent Application Publication
(10) Pub. No.: US 2010/0144387 A1
(43) Pub. Date: Jun. 10, 2010

(54) MULTIFUNCTIONAL PORTABLE ELECTRONIC DEVICE

(75) Inventor: MENG-CHIEH CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/547,705

(22) Filed: Aug. 26, 2009

(30) Foreign Application Priority Data
Dec. 5, 2008 (CN) 200810305997.6

(51) Int. Cl. H04M 1/00; H04N 7/18; G08B 21/00

(52) U.S. Cl. 455/556.1; 348/61; 340/540; 348/E07.085; 382/135

(57) ABSTRACT

A multifunctional portable electronic device includes a camera module, a central processing unit and a display module. The came module is configured to capture images of the anti-counterfeit parts of a to-be-tested item. The central processing unit is configured to receive the images captured by the camera module, compare the images with anti-counterfeit template images of anti-counterfeit parts of a genuine item pre-stored in memory, and determine whether the to-be-tested item is genuine. The display module is configured to show the determined result.

### BACK GROUND

1. Technical Field

The exemplary disclosure generally relates to a multifunctional portable electronic device with anti-counterfeiting identification function.

2. Description of Related Art

Many techniques are known for determining the denomination and authenticity of a received banknote. The banknote validating devices are generally incorporated in apparatus which is capable of both receiving and dispensing banknotes, and in some cases the apparatus includes storage for banknotes to be dispensed which is replenished by received banknotes. People often need to take along a validator or a money detector to identify the anti-counterfeiting identification of the money to ensure/detect whether the money is a counterfeit money or not among the cash transaction activities as shopping, travelling, etc. However, most of the existing banknote validating devices or validators are larger in size, expensive and hard to carry about.

Therefore, there is room for improvement within the art.

### BRIEF DESCRIPTION OF THE DRAWINGS

Many aspects of the exemplary multifunctional portable electronic device can be better understood with reference to the following drawings. These drawings are not necessarily drawn to scale, the emphasis instead being placed upon clearly illustrating the principles of the present multifunctional portable electronic device. Moreover, in the drawings like reference numerals designate corresponding parts throughout the several views. Wherever possible, the same reference numbers are used throughout the drawings to refer to the same or like elements of an embodiment.

FIG. 1 shows a block diagram of a multifunctional portable electronic device according to an exemplary embodiment.

FIG. 2 shows an operation flowchart of the multifunctional portable electronic device in detecting.

### DETAILED DESCRIPTION

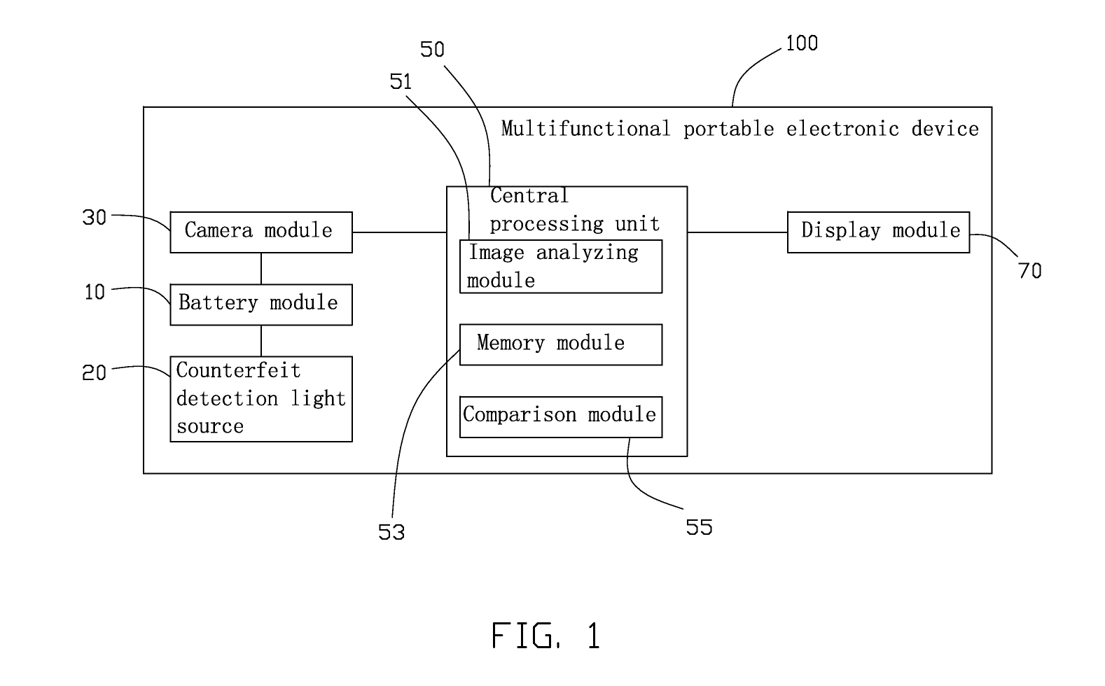

FIG. 1 shows a block diagram of a multifunctional portable electronic device 100 according to an exemplary embodiment. The multifunctional portable electronic device 100 can be a mobile phone, a personal digital assistant (PDA), and etc. The multifunctional portable electronic device 100 includes a battery module 10, a counterfeit detection light source 20, a camera module 30, a central processing unit 50, and a display module 70. The battery module 10 electrically connects with the counterfeit detection light source 20, the camera module 30, the central processing unit 50, and the display module 70.

The counterfeit detection light source 20 is configured to emit a predetermined type of light on a predetermined area of a to-be-tested item where anti-counterfeit markings are usually placed. The counterfeit detection light source 20 can be a complex or composite light illuminant to provide/emit predetermined type of light. The predetermined type of light includes at least one item selected from the group consisting of ultraviolet light, purple light, blue-violet light, infrared light, etc. Usually, a to-be-tested item (e.g. money) will reveal anti-counterfeit markings at the predetermined areas, such as a color ink layer, a bill of value, a fluorescence fiber, a fluorescence ink, and etc., when exposed by ultraviolet light, purple light, or blue-violet light emitted by the counterfeit detection light source 20 to identify if the item is genuine. Preferably, the wavelength of ultraviolet light source may be 10 nm-400 nm.

The camera module 30 electrically connects with the battery module 10 and the central processing unit 50. The camera module 30 is configured to capture an image or images of the to-be-tested item illuminated by the counterfeit detection light source 20 and send a to-be-tested item image to the central processing unit 50.

The central processing unit 50 electrically connects with the display module 70 and is configured to receive the to-be-tested item images, compare the to-be-tested item images with anti-counterfeit template images of a genuine item pre-stored in memory, and determine whether the to-be-tested item is genuine. The central processing unit 50 includes an image analyzing module 51, a memory module 53 and a comparison module 55. The image analyzing module 51 is configured to analyze predetermined areas of the to-be-tested item image and acquire optical parameters, i.e., R, G, B of the predetermined areas of the to-be-tested item. The memory module 53 is configured to include memory templet information e.g. the anti-counterfeit template images of the anti-counterfeit parts of the genuine item. The comparison module 55 is configured to compare the images with the templet information e.g. anti-counterfeit template images of anti-counterfeit parts of a genuine item stored in the memory module 53, then, send the result to the display module 70.

The display module 70 electrically connects with the central processing unit 50 and is configured to show the determined result.

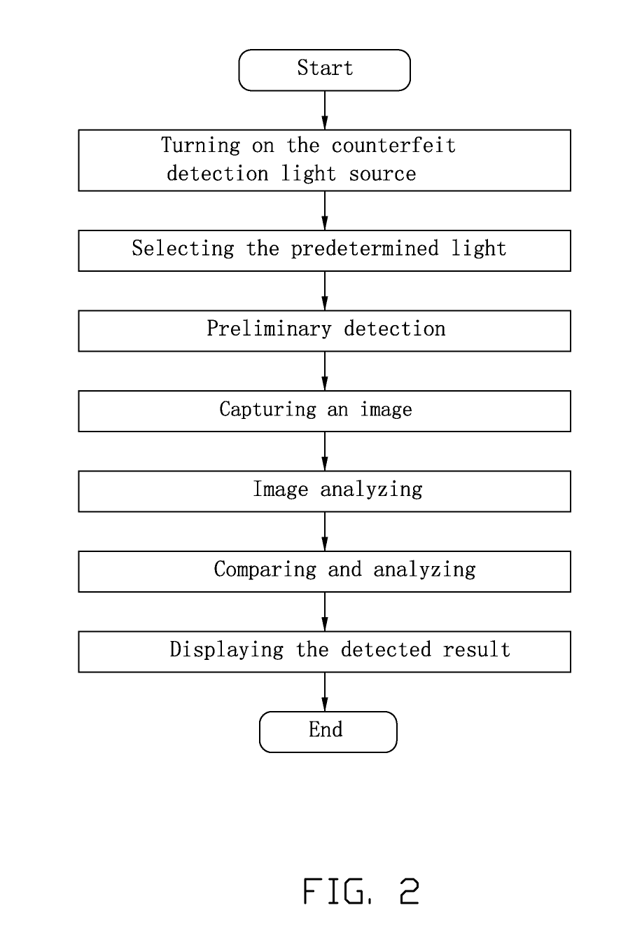

Also referring to FIG. 2, when using the multifunctional portable electronic device 100 to detect a to-be-tested item such as money, firstly, turning on the counterfeit detection light source 20 and selecting the predetermined type of light to project on the predetermined area of the to-be-tested item. Then, observing the fluorescent response at the predetermined area of the to-be-tested item to initially determine if the to-be-tested item is genuine with the naked eye. Secondly, capturing an image or images of the anti-counterfeit parts of the to-be-tested item by utilizing the camera module 30. Thirdly, the central processing unit 50 receives the images captured by the camera module 30, the image analyzing module 51 of the central processing unit 50 analyzes the image/images of the anti-counterfeit part of the to-be-tested item to acquire the optical parameters R, G, B of the image. The comparison module 55 of the central processing unit 50 compares the images with anti-counterfeit template images of anti-counterfeit parts of a genuine item pre-stored in the memory module 53, and determine whether the to-be-tested item is genuine. The display module 70 shows the determined result of the to-be-tested item.

It is to be understood that the memory module 53 could be configured to pre-store the templet information.

It is to be understood that the display module 70 could be configured as a warning device, when detected that the pre-detected body is counterfeited, the warning device would send out an audible warning.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multifunctional portable electronic device capable of verifying counterfeit item comprising:
a counterfeit detection light source for emitting predetermined type of light for projection on anti-counterfeit parts of a to-be-tested item where anti-counterfeit markings are located;
a camera module configured for capturing an image/images of the anti-counterfeit parts of the to-be-tested item illuminated by the counterfeit detection light source;
a central processing unit configured to receive the image/images captured by the camera module, compare the image/images with anti-counterfeit template images of anti-counterfeit parts of a genuine item pre-stored in memory, and determine whether the to-be-tested item is genuine; and
a display module configured to show the determined result.

2. The multifunctional portable electronic device as claimed in claim 1, wherein the central processing unit includes an image analyzing module configured to analyze the image and acquire optical parameters of the images of the anti-counterfeit parts of the to-be-tested item.

3. The multifunctional portable electronic device as claimed in claim 2, wherein the central processing unit further includes a memory module configured to memory templet information of a genuine item.

4. The multifunctional portable electronic device as claimed in claim 3, wherein the central processing unit further includes a comparison module configured to compare the images with the templet information of a genuine item stored in the memory module, then, send the result to the display module.

5. The multifunctional portable electronic device as claimed in claim 3, wherein the counterfeit detection light source is a complex or composite light illuminant.

6. The multifunctional portable electronic device as claimed in claim 5, wherein the predetermined type of light emitted by counterfeit detection light source includes at least one of ultraviolet light, purple light, blue-violet light, and infrared light.

7. The multifunctional portable electronic device as claimed in claim 6, wherein the wavelength of ultraviolet light source is 10 nm˜400 nm.

8. The multifunctional portable electronic device as claimed in claim 3, wherein the memory module is configured to pre-store the anti-counterfeit template images of the anti-counterfeit parts of the genuine item.

9. The multifunctional portable electronic device as claimed in claim 1, wherein the display module is configured as a warning device to send out an audible warning when detecting that the to-be-tested item is counterfeit.

10. The multifunctional portable electronic device as claimed in claim 1, wherein the multifunctional portable electronic device further includes a battery module electrically connecting with the camera module, the central processing unit and the display module to provide electric power.

11. The multifunctional portable electronic device as claimed in claim 1, wherein the multifunctional portable electronic device is a mobile phone or a personal digital assistant.

12. A multifunctional portable electronic device capable of verifying counterfeit item comprising:
a camera module configured for capturing images of the anti-counterfeit parts of a to-be-tested item where anti-counterfeit markings are located;
a central processing unit configured to receive the images captured by the camera module, compare the images with anti-counterfeit template images of anti-counterfeit parts of a genuine item pre-stored in memory, and determine whether the to-be-tested item is genuine; and
a display module configured to show the determined result.

13. The multifunctional portable electronic device as claimed in claim 12, wherein the central processing unit includes an image analyzing module configured to analyze the image and acquire optical parameters of the images of the anti-counterfeit parts of the to-be-tested item.

14. The multifunctional portable electronic device as claimed in claim 13, wherein the central processing unit further includes a memory module configured to memory templet information of a genuine item.

15. The multifunctional portable electronic device as claimed in claim 14, wherein the central processing unit further includes a comparison module configured to compare the images with the templet information of a genuine item stored in the memory module, then, send the result to the display module.
